(19) United States
(12) Patent Application Publication
(10) Pub. No.: US 2009/0226700 A1
(43) Pub. Date: Sep. 10, 2009

(54) Composite Metal-Aerogel Material

(75) Inventors: Lorenz Ratke, St. Augustin (DE); Sabine Brück, Düren (DE); Sonja Steinbach, Rösrath (DE)

Correspondence Address: HARNESS, DICKEY & PIERCE, P.L.C., P.O. BOX 828, BLOOMFIELD HILLS, MI, 48303, US

(73) Assignee: DEUTSCHES ZENTRUM FUR LUFT-UND RAUMFAHRT E.V., Koeln (DE)

(21) Appl. No.: 12/280,574

(22) PCT Filed: Feb. 26, 2007
(86) PCT No.: PCT/EP2007/051792

§ 371 Date: Oct. 9, 2008

(30) Foreign Application Priority Data
Mar. 3, 2006 (DE) 10 2006 009 917.6

(51) Int. Cl. B32B 3/26; B22D 23/00

(52) U.S. Cl. 428/316.6; 164/55.1

(57) ABSTRACT

The present application relates to a porous composite material consisting of a metal matrix with embedded nano-structured materials.

### FIELD

The present disclosure relates to a composite material consisting of a metal matrix with embedded nano-structured materials having macroscopic dimensions (micrometers to millimeters).

### BACKGROUND

Most of the processes developed in recent decades for the preparation of porous metals yield closed-cell or open-cell foams and sponges. A foam-like morphology is necessary for high mechanical properties (rigidity) and thus for structural applications, such as light-weight building elements in vehicle construction. Functional applications, such as filters, sound absorbers (silencers) or heat exchangers, require an open-cell structure in order that a fluid medium can penetrate into or through the foam or sponge. To date, open-cell foams or sponges have been prepared by the process step of investment casting. However, this process is very complicated and thus expensive. An alternative process that has long been known is the casting of metallic melts around fillers. After the fillers have been removed, a spongy open-cell body with interconnected cells is obtained. Metallic foams are usually prepared by introducing gas into a melt or by thermal decomposition of hydrides, for example. In principle, foam preparation is a non-stationary, unstable and hardly controllable process. The methods known to date are documented in detail in the literature (J. Banhart, J. Baumeister, M. Weber, Metallschaum, Aluminium, 70, 209-211 (1994); J. Banhart, J. Baumeister, M. Weber: Geschäumte Metalle als neue Leichtbauwerkstoffe, VDI Berichte 1021, 277-284, (1993); H. Cohrt, F. Baumgärtner, D. Brungs, H. Gers: Grundzüge der Herstellung von Aluminiumschaum auf PM-Basis, Tagungsband des ersten deutschsprachigen Symposiums Metallschäume (Proceedings of the first German Symposium on Metal Foams); Bremen (Germany), March 6-7; 91-102 (1997); J. J. Bikerman: Foams: Theory and Industrial Applications, Reinhold, New York, Chapter 4 (1953); M. Weber: Herstellung von Metallschäumen und Beschreibung der Werkstoffeigenschaften, Dissertation, TU Clausthal (1995)).

“Foams” within the meaning of the invention is essentially interchangeable with “sponges” and, being colloid-chemical systems, are structures made of gas-filled spherical or polyhedral cells limited by solid struts. The struts, interconnected through so-called nodes, form a contiguous skeleton. Between the struts, foam lamellae are spanned (closed-cell foam). If the foam lamellae are disrupted or flow back into the struts at the end of foam formation, an open-cell foam is obtained. Foams are thermodynamically unstable, because surface energy can be won by decreasing the surface area. The stability and thus existence of a foam is thus dependent on the extent to which its self-destruction can be successfully prevented.

DE 40 18 360 C1 describes the foaming of aluminum alloys by means of titanium hydride powder. DE 41 01 630 C2 describes the foaming of other metals as well and of alloys, such as bronze, also by means of titanium hydride powder.

WO 96/19314 A1 describes a composite material as a solder material having a high mechanical stability, consisting of high melting and low melting metal components and a filler component. After soldering, intermetallic phases having a melting point of above the processing temperature are formed having internal surfaces to the filler components. These interior surfaces improve the mechanical stability of the solder bond.

The German translation DE 603 01 737 T2 derived from EP 1 333 222 B1 describes a process for preparing a superinsulating composite plate comprising a porous superinsulating material having a micro- or nanocell structure as an insulating core surrounded by a dense barrier material under vacuum.

What many of the above mentioned processes, especially the foaming of metals by using hydride powders, have in common is that such metallic foams are often not reproducible in their properties and have a non-uniform distribution of the pores. Many of these processes result in metal foams having a porosity of more than 85%, so that such metal foams are unsuitable for applications in which a high mechanical strength and especially a high compressive strength is necessary.

If the metal foams are obtained by casting around fillers, the fillers must be removed tediously in an additional process step.

### SUMMARY

Thus, it is the object of the present invention to provide as simply a preparation as possible of metal foams that have a high mechanical stability despite of a low weight.

### DETAILED DESCRIPTION

In a first embodiment, this object of the invention is achieved by a composite material containing pores and consisting of a metal matrix with embedded nano-structured materials.

Pores within the meaning of the invention are those volume ranges of the composite material that are not filled with metal and have a density within a range of from 0.001 g/cm³ to 0.1 g/cm³. The pores may advantageously be partially or completely filled with the embedded nano-structured materials. Thus, the designation “pores” according to the invention, pores being classically filled with gas, deliberately deviates from the previous understanding since the pores according to the invention may also be filled, for example, with solids, such as aerogel.

Nano-structured materials within the meaning of the invention include those having elevations on their surface, at least 80% of the elevations having a distance from neighboring elevations within a range of from 5 nm to 500 nm, wherein the elevations themselves have a height within a range of from 5 nm to 500 nm. In addition, this means materials whose inner structure consists of nanoparticles, i.e., particles having a diameter within a range of from 2 to 100 nm and being cross-linked. If the nano-structured materials are in the form of particles, the particle size is advantageously within a range of from 0.1 to 5 mm.

Advantageously, the porosity of the composite material according to the invention is within a range of from 20 to 80%, more preferably within a range of from 30 to 70%. The “porosity” within the meaning of the invention is the ratio of the weight of a particular given volume of the composite material according to the invention to the weight of a correspondingly pore-free metal body having the same volume. If the porosity is too high, the composite material has a mechanical strength that is too low for many applications. If the porosity is too low, the weight of the composite material is too high for many applications. In this case, due to the fact that the pores may advantageously be filled by the nano-structured materials, the porosity thus essentially corresponds to the volume content of nano-structured materials supposing that the nano-structured materials have a negligible weight.

Preferably, the volume of the individual filled pores is adjusted in such a way that the volume of at least 80% of the pores is at most 500 mm³ each. If the volume of more than 80% of the pores is more than 500 mm³ each, such composite materials do not have sufficient mechanical loading capacity. The pore size of the composite material according to the invention can be determined, for example, according to ASTM 3576-77.

Advantageously, the nano-structured materials are chemically inert. “Chemically inert” within the meaning of the invention means that the nano-structured materials do not undergo a chemical reaction with molten metal. This is particularly advantageous because degradation, for example, oxidation, of the metal matrix can thus be avoided.

The nano-structured materials are preferably aerogels or expanded layer silicates. Due to the low density of such materials, metallic melts can be cast around particles of these materials during the preparation thereof to form the pores of the composite material according to the invention without the necessity to remove such materials from the composite material. This holds, in particular, for aerogel because the density of the aerogel employed according to the invention is advantageously within a range of from 0.005 to 0.025 g/cm³. Aerogel is particularly advantageous because it is open-cell in nature, has a high specific surface area and therefore can be employed in both open-cell and closed-cell materials. In contrast, closed-cell nano-structured materials could not result in open-cell composite materials.

In the case where the nano-structured materials comprise layer silicates, these are advantageously selected from vermiculites, biotites or zeolites as well as mixtures thereof (for example, expanded mica).

If the nano-structured materials contained according to the invention are aerogels, they advantageously comprise silica aerogels. Even though the composite materials according to the invention can be obtained with hydrophilic aerogels, hydrophobic aerogels are preferred because they are particularly readily wetted by a metal melt. The pore diameter of the aerogel itself is advantageously within a range of from 5 to 50 nm. The specific surface area of the employed aerogels according to the invention is advantageously within a range of from 200 to 1500 m²/g. Advantageously, the thermal conductivity of the aerogels is within a range of from 0.005 to 0.03 W/mK at 25° C. The aerogel is preferably in the form of granules, especially granules in which the grain size distribution is such that at least 80% by volume of the aerogel granules have a granule size within a range of from 0.1 to 5 mm. The shape of the granules of the aerogel is advantageously selected from spherical, polyhedral, cylindrical or plate-like.

The metal of the matrix is advantageously selected from aluminum, zinc, tin, copper, magnesium, silicon or an alloy of at least two of such metals. The metal matrix more preferably consists of aluminum or an aluminum alloy. In addition, AlSi, AlSiMg, AlCu, bronze or brass are more particularly preferred as alloys. The melting point of the metal matrix according to the invention is advantageously within a range of from 600 to 900° C., especially within a range of from 600 to 750° C.

Although aerogel has been considered very unstable mechanically to date, the present invention surprisingly succeeded for the first time to process aerogel with a metal melt to form a composite material while its structure is maintained. Thus, by selecting the aerogels, a cell morphology with defined pore sizes in the metal foam can be adjusted for the first time. In contrast to the conventional preparation of a metallic foam, the aerogel need no longer be removed due to its low weight.

The composite materials according to the invention advantageously have a compression hardness or compressive strength during an upset of 20% of at least 8 MPa (according to DIN 53577/ISO 3386). The bulk density of the composite materials according to the invention is advantageously within a range of from 0.3 to 2 g/cm³, especially within a range of from 1 to 2 g/cm³. If the density of the composite material is too high, the composite material is unsuitable for many applications in which light-weight materials are necessary. However, if the density is too low, the resulting composite materials do not have sufficient mechanical stability.

In another embodiment, the object of the invention is achieved by a process for the preparation of the composite material according to the invention which is characterized in that the following steps are performed:

a) externally mixing the nano-structured material with a metal melt and transferring it into a casting mold; or

a′) mixing the nano-structured material with a metal melt in a casting mold;

b) allowing to solidify, and

c) demolding.

Alternatively, it is also possible to mix the nano-structured materials with a metal powder, followed by melting the metal.

Thus, the object is achieved by stirring, for example, polyhedral or spherical nano-structured silica aerogel particles into an optionally thixotropic metal melt. Since the aerogel is advantageously chemically inert, no reaction occurs between the metal and the melt. During the stirring, the metal solidifies and entraps the aerogel particles. While still in a soft state, the metal composite can be advantageously compressed so that a desired shape can be provided. The metal melt is “thixotropic” within the meaning of the invention if its temperature is between the liquidus and solidus temperatures.

The process may also be advantageously based on the backfilling of an agglomeration of aerogel granules with a metal melt. The melt, to which pressure is advantageously applied, penetrates the spaces and fills the corner-like spaces as well. After solidification, the aerogel need no longer be removed because it accounts for only a fraction of the total weight, having a density of, for example, about 0.015 g/cm³. Advantageously, the application of pressure may be realized by the centrifugal force in spin casting for smaller components, and in die casting for larger components.

In another embodiment, the object of the invention is achieved by using the composite materials according to the invention in structural lightweight construction, especially in applications for motor vehicles or in portable electronic devices.

### EXAMPLES

### Example 1

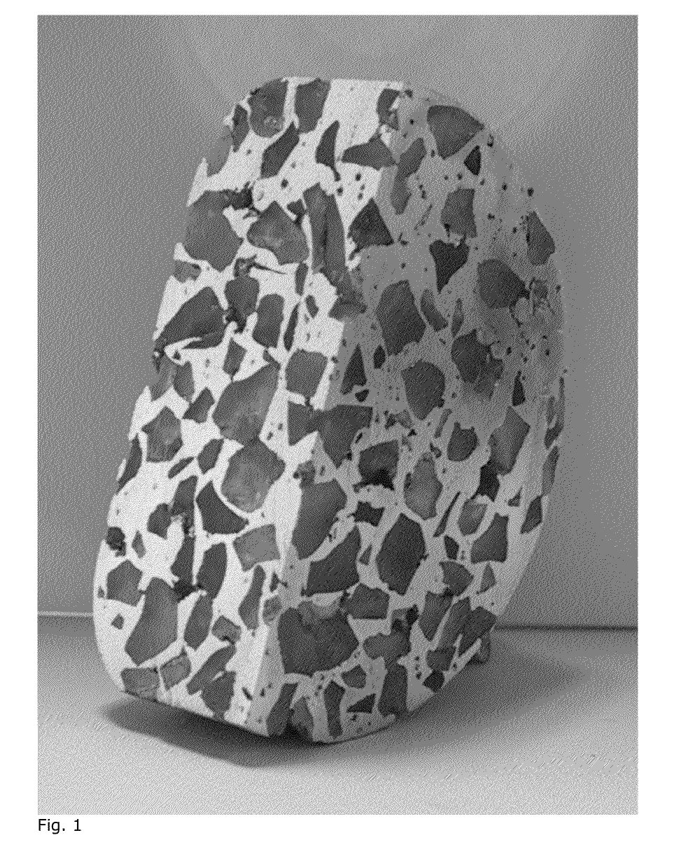

Silica aerogel granules were obtained from aerogel monoliths by grinding. The thus obtained hydrophilic polyhedral silica aerogel (Airglas®, Staffanstorp, Sweden) was baked out at 600° C. as granules first. An AlSi alloy (aluminum containing 7% by weight of silicon) was molten and subsequently brought into the thixotropic (semisolid) state by slowly stirring while the temperature was decreased into the interval between the liquidus and solidus temperatures. Aerogel granules (grain size 0.1 mm to 5 mm) were added to the metal with stirring up to a proportion of 40% by volume. Mixing was conducted manually. The semisolid metal prevented the extremely lightweight silica aerogel granules from floating on the top. As soon as stirring was no longer possible due to advanced solidification, pressure was applied to the compound, which was still soft and could thus be brought into any shape desired. The porosity was 40% at pore diameters within a range of from 0.1 to 5 mm. FIG. 1 shows the metallic composite material according to Example 1.

### Example 2

Aerogel granules according to Example 1 were backfilled with an AlSiMg alloy (aluminum containing 7% by weight of silicon and 0.6% by weight of magnesium) at 720° C. For this purpose, a casting mold was filled with a loose packing of the aerogel granules. The casting was effected from the bottom, so that the melt completely filled the spaces between the particles with a slight pressure. In this case, a weakly increased pressure of 1 atm was sufficient. After the casting was complete, a metallic composite of aerogel granules and metal was obtained.

### Example 3

The processes mentioned in Examples 1 and 2 were also performed with spherical aerogel granules, so-called Aerogel Beads of Cabot Corp. When this filler was selected, the later cell morphology was clearly predetermined.

### Example 4

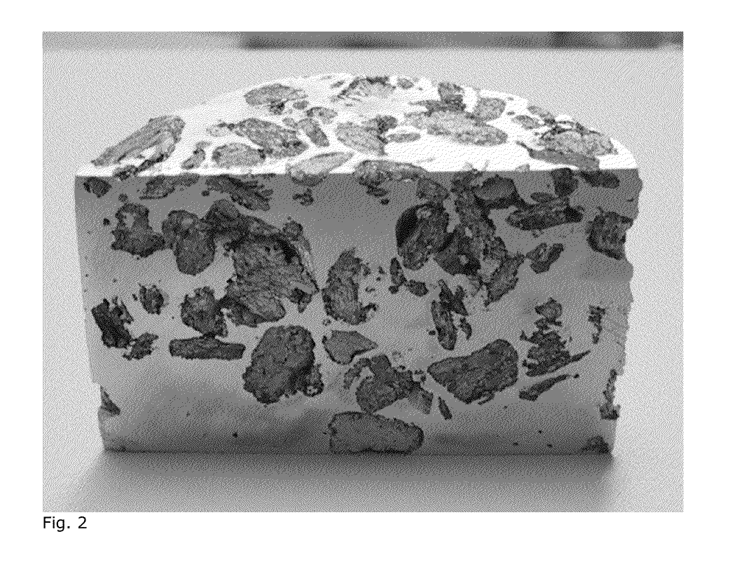

The thermally expanded layer silicates vermiculite, biotite and muscovite (3 g) were each added to an AlCu melt (300 g; aluminum containing 9% by weight of copper) at 730° C. and carefully admixed by stirring until solidification occurred. After solidification, a composite of inorganic silicates and a metallic alloy was obtained. The porosity was 30% with pore diameters within a range of from 0.1 to 7 mm. FIG. 2 shows the metallic composite according to Example 4 with coarse particles of expanded biotite.

### Example 5

The aerogel granules as in Example 1 were filled into a refractory casting mold until the volume was completely occupied, and inserted in a spin casting system. The crucible of the spin casting system (AuTi2.0, Linn High-Term, Eschfelden) was filled with an alloy (about 100 g) of aluminum containing 7% by weight of silicon. By the normal process of spin casting, the cavities between the aerogel particles were completely filled with metal. The volume proportion of pores completely filled with aerogel could be varied between 50 and 80% by the particle size distribution of the filler particles.

1. A pore-containing nanostructured composite material consisting of a metal matrix with embedded aerogels.

2. The composite material according to claim 1, characterized in that said metal matrix comprises aluminum or an aluminum alloy.

3. The composite material according to claim 1, characterized in that said nanostructured materials are chemically inert.

4. The composite material according to claim 1, characterized in that said aerogel is a silica aerogel.

5. The composite material according to claim 1, characterized in that its porosity is within a range of from 20 to 80%.

6-7. (canceled)

8. The composite material according to claim 2, characterized in that said nanostructured materials are chemically inert.

9. A process for the preparation of a composite material according to any of claims 1 to 5 and 8, characterized in that the following steps are performed:
a) externally mixing the aerogel with a metal melt and transferring it into a casting mold; or
a′) mixing the aerogel with a metal melt in a casting mold;
b) allowing the mixture to solidify, and
c) demolding.

10. Use of the composite materials according to any of claims 1 to 5 and 8 in structural lightweight construction.
